(19) United States
(12) Patent Application Publication
(10) Pub. No.: US 2020/0192406 A1
(43) Pub. Date: Jun. 18, 2020

(54) CONTROL DEVICE, PHOTOGRAPHING DEVICE, MOBILE BODY, CONTROL METHOD AND PROGRAM

(71) Applicant: SZ DJI TECHNOLOGY CO., LTD., Shenzhen (CN)

(72) Inventors: Yoshinori NAGAYAMA, Shenzhen (CN); Qingyu LU, Shenzhen (CN); Tianyi YU, Shenzhen (CN)

(21) Appl. No.: 16/799,643

(22) Filed: Feb. 24, 2020

Related U.S. Application Data
(63) Continuation of application No. PCT/CN2017/118057, filed on Dec. 22, 2017.

(30) Foreign Application Priority Data
Aug. 28, 2017 (JP) 2017-163568

(51) Int. Cl. G05D 1/10; G02B 7/08; G03B 17/56; G03B 15/00; H02P 8/22; B64C 39/02; B64D 47/08; G05D 1/00

(52) U.S. Cl. CPC G05D 1/101; G02B 7/08; G03B 17/561; G03B 15/006; H02P 8/22; B64C 39/024; B64C 2201/108; G05D 1/0011; G05D 1/0094; B64C 2201/027; B64C 2201/042; B64C 2201/127; B64C 2201/146; B64D 47/08

(57) ABSTRACT

A control apparatus includes a processor and a memory storing a program that, when executed by the processor, causes the processor to acquire at least one of movement information related to a movement status of a device having a step motor or environment information related to an environment where the device is located, and select one of a plurality of control modes to control the step motor according to the at least one of the movement information or the environment information. The plurality of control modes includes a first control mode and a second control mode. In the second control mode, a number of steps is less than that in the first control mode, and a force to keep a rotor of the step motor at a position is smaller than that in the first control mode or a power consumption is less than that in the first control mode.

### CROSS-REFERENCE TO RELATED APPLICATIONS

This application is a continuation of International Application No. PCT/CN2017/118057, filed Dec. 22, 2017, which claims priority to Japanese Application No. 2017-163568, filed Aug. 28, 2017, the entire contents of both of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a control device (control apparatus), a photographing device, a mobile body, a control method, and a program.

### BACKGROUND

Patent Document 1 describes that the gain is set to a value higher than a first gain of the step motor in which a drive power value higher than a specified power value is supplied to a step motor, and after this abnormal state continues for a predetermined time, the gain is set to be a second gain higher than the first gain.

Patent Document 1: Japanese Patent Application Laid-Open No. 2015-119571.

### SUMMARY

In accordance with the disclosure, there is provided a control device including a processor and a memory storing a program. The program is executed by the processor to cause the processor to acquire at least one of movement information related to a movement status of a device having a step motor or environment information related to an environment where the device is located, and select one of a plurality of control modes to control the step motor according to the at least one of the movement information or the environment information. The plurality of control modes includes a first control mode and a second control mode, where a number of steps of the second control mode is less than a number of steps of the first control mode, and a force to keep a rotor of the step motor at a position in the second control mode is smaller than a force to keep the rotor at the position in the first control mode or a power consumption of the second control mode is less than a power consumption of the first control mode.

Also in accordance with the disclosure, there is provided a photographing device including the controller, the step motor, and an optical component driven by the step motor.

Also in accordance with the disclosure, there is provided a mobile body including the photographing device.

Also in accordance with the disclosure, there is provided a control method including acquiring at least one of movement information related to a movement status of a device having a step motor or environment information related to an environment where the device is located, and selecting one of a plurality of control modes to control the step motor according to the at least one of the movement information or the environment information. The plurality of control modes include a first control mode and a second control mode, where a number of steps of the second control mode is less than a number of steps of the first control mode, and a force to keep a rotor of the motor at a position in the second control mode is smaller than a force to keep the rotor at the position in the first control mode or a power consumption of the second control mode is smaller than a power consumption of the first control mode.

### BRIEF DESCRIPTION OF THE DRAWINGS

FIG. 1 shows an exemplary unmanned aerial vehicle (UAV) and a remote operation device according to an embodiment of the disclosure.

FIG. 2 shows functional blocks of the UAV according to an embodiment of the disclosure.

FIG. 3 shows a step motor according to an embodiment of the disclosure.

FIG. 4 is a diagram showing voltage pattern in micro-step mode according to an embodiment of the disclosure.

FIG. 5 is a diagram showing voltage pattern in two-phase excitation mode according to an embodiment of the disclosure.

FIG. 6 is a flow chart of a lens driving method according to an embodiment of the disclosure.

FIG. 7 is a diagram of a hardware configuration according to an embodiment of the disclosure.

### REFERENCE NUMERALS

10 Unmanned Aerial Vehicle (UAV)
20 UAV body
30 UAV Controller
32 Memory
34 Communication Interface
40 Propeller
41 Global Position System (GPS) Receiver
42 Inertia Measurement Unit
43 Magnetic Compass
44 Barometric Altimeter
45 Temperature Sensor
46 Humidity Sensor
50 Gimbal
60 Photographing Device
100 Photographing Device
102 Photographing Unit
110 Photographing Controller
116 Gyro Sensor
120 Image Sensor
130 Memory
200 Lens Unit
210 Lens
212 Lens Driver
214 Position Sensor
220 Lens Controller
222 Memory
224 Acquisition Unit
226 Drive Controller
230 Shutter
232 Shutter Driver
234 Aperture
236 Aperture Driver
238 Filter
240 Filter Driver
300 Remote Operation Device
402 Rotor
404 Stator
406A, 406B, 406A′, 406B′ Coil
1200 Computer
1210 Host Controller
1212 Central Processing Unit (CPU)
1214 Random-Access Memory (RAM)
1220 I/O Controller
1222 Communication Interface
1230 Read-Only Memory (ROM)

### DETAILED DESCRIPTION OF THE EMBODIMENTS

The present disclosure will be described with embodiments of the disclosure, but the following embodiments do not limit the disclosure. All combinations of features described in the embodiments are not necessarily required for the solution of the embodiments. Those of ordinary skill in the art can perform various changes or improvements to the following embodiments. All the embodiments with the changes or improvements are within the scope of the present disclosure.

Various embodiments of the present disclosure will be described with reference to flowcharts or block diagrams. A block can represent (1) a stage of a process for operation execution or (2) a functional unit of a device for operation execution. A stage or unit can be implemented by a programmable circuit and/or a processor. A special purposed circuit may be a digital and/or analog hardware circuit including an integrated circuit (IC) and/or a discrete circuit. The programmable circuit may include a reconfigurable hardware circuit. The reconfigurable hardware circuit may include logical AND, logical OR, logical XOR, logical NAND, logical NOR, another logical operation, a trigger, a register, a field programmable gate array (FPGA), a programmable logic array (PLA), or another memory component.

A computer-readable medium may include any physical device, which can store instructions to be executed by an appropriate device. The instructions, stored in the computer-readable medium, can be executed to perform operations specified according to the flowchart or the block diagram. The computer-readable medium may include an electronic storage medium, a magnetic storage medium, an optical storage medium, an electromagnetic storage medium, a semiconductor storage medium, etc. The computer-readable medium may more specifically include floppy disk, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray(®) disc, memory stick, integrated circuit card, etc.

A computer-readable instruction may include any one of source code or object code described by any combination of one or more programming languages. The source or object codes include traditional procedural programming languages. The traditional procedural programming languages can be assembly instructions, instruction set architecture (ISA) instructions, machine instructions, machine-related instructions, a microcode, firmware instructions, status setting data, or object-oriented programming languages and “C” programming languages or similar programming languages such as Smalltalk, JAVA (registered trademark), C++, etc. Computer-readable instructions can be provided locally or be provided via a local area network (LAN) or a wide area network (WAN) such as the Internet to a general-purpose computer, a special-purpose computer, or a processor or programmable circuit of other programmable data processing devices. The processor or the programmable circuit can execute computer-readable instructions to perform the operations specified in the flowchart or block diagram. Examples of the processor include a computer processor, a processing unit, a microprocessor, a digital signal processor, a controller, a microcontroller, etc.

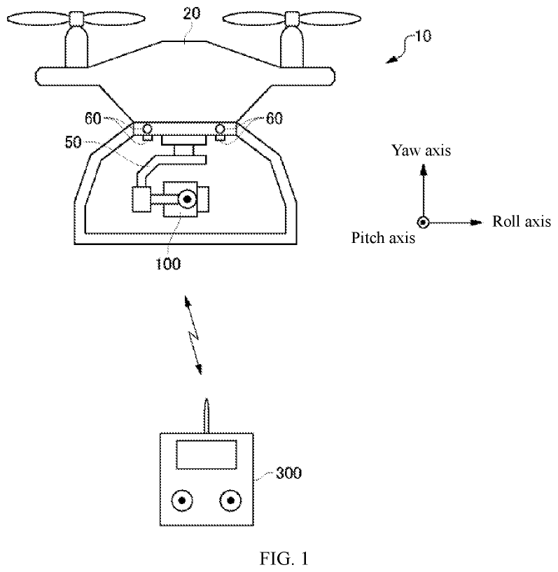

FIG. 1 shows an unmanned aerial vehicle (UAV) 10 and a remote operation device 300 according to the disclosure. The UAV 10 includes a UAV body 20, a gimbal 50, a plurality of photographing devices 60, and a photographing device 100. The gimbal 50 and the photographing device 100 are an example of a photographing system. The UAV 10 is an example of a mobile body propelled by a propeller. Other examples of the mobile body include other aircrafts movable in the air, vehicles movable on the ground, ships movable in the water, etc.

The UAV body 20 includes a plurality of rotors. The plurality of rotors are an example of the propeller. The UAV body 20 controls the rotation of the plurality of rotors to cause the UAV to fly. In some embodiments, for example, four rotors are provided, but the number of rotors is not limited to four. In some embodiments, the UAV 10 may be a fixed-wing aircraft without rotors.

The photographing device 100 can be a camera for capturing images an object in a desired photographing range. The gimbal 50 can rotatably support the photographing device 100. The gimbal 50 is an example of a supporting structure. For example, the gimbal 50 uses an actuator to rotatably support the photographing device around a pitch axis. The gimbal 50 uses actuators to further rotatably support the photographing device 100 around a roll axis and a yaw axis. The gimbal 50 can change an attitude of the photographing device 100 by rotating the photographing device 100 around at least one of the yaw axis, the pitch axis, or the roll axis.

The plurality of photographing devices 60 can be sensory cameras for capturing the surroundings of the UAV 10 to control the flight of the UAV 10. Two photographing devices 60 can be provided at the front of the UAV 10. Other two photographing devices 60 can be provided at the bottom of the UAV 10. The two photographing devices 60 at the front can be paired to function as a stereo camera. The two photographing devices 60 at the bottom can also be paired to function as a stereo camera. 3D spatial data of the UAV 10 surroundings can be generated based on the images captured by the plurality of photographing devices 60. The number of the photographing devices 60 at the UAV 10 is not limited to four, as long as the UAV 10 has at least one photographing device 60. The UAV 10 can also have at least one photographing device 60 at each of the head, the back, the side, the bottom, and the top of the UAV 10. A configurable angle of view of the photographing device 60 may be greater than a configurable angle of view of the photographing device 100. The photographing device 60 may include a fixed focal length lens or a fisheye lens.

The remote operation device 300 communicates with the UAV 10 to remotely operate the UAV 10. The remote operation device 300 can wirelessly communicate with the UAV 10. The remote operation device 300 sends instruction information of various instructions related to movements of the UAV 10 such as ascend, descend, accelerate, decelerate, move forward, move backward, rotate, etc. The instruction information can include, e.g., instruction information to increase the altitude of the UAV 10. The instruction information can indicate the altitude at which the UAV 10 should be located. The UAV 10 can move to the altitude indicated by the instruction information received from the remote operation device 300. The instruction information may include an ascending instruction to instruct the UAV 10 to ascend. The UAV 10 ascends when receiving the ascending instruction. However, when the altitude of the UAV 10 reaches an upper limit, the UAV 10 can be restricted from ascending even though the UAV 10 receives the ascending instruction.

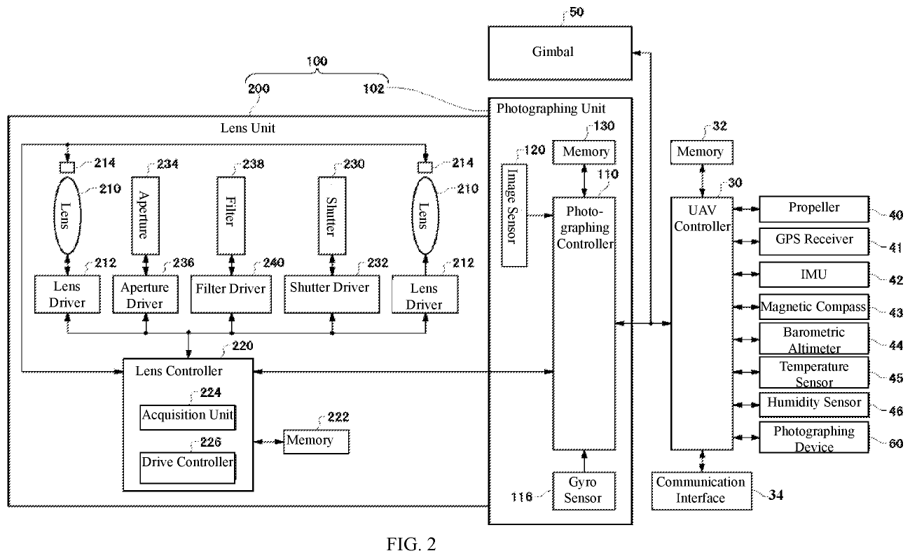

FIG. 2 shows an example of functional blocks of the UAV 10 according to the disclosure. The UAV 10 includes a UAV controller 30, a memory 32, a communication interface 34, a propeller 40, a GPS receiver 41, an inertia measurement device 42, a magnetic compass 43, a barometric altimeter 44, a temperature sensor 45, a humidity sensor 46, a gimbal 50, a photographing device 60, and a photographing device 100.

The communication interface 34 is communicatively connected to the remote operation device 300 or other devices. The communication interface 34 can receive the instruction information including various instructions for the UAV controller 30 from the remote operation device 300. The memory 32 stores a program required for the UAV controller 30 to control the propeller 40, the GPS receiver 41, the inertial measurement device (IMU) 42, the magnetic compass 43, the barometric altimeter 44, the temperature sensor 45, the humidity sensor 46, the gimbal 50, the photographing device 60, the photographing device 100, etc. The memory 32 may be a computer-readable storage medium and may include at least one flash memory selected from the group consisting of SRAM, DRAM, EPROM, EEPROM, USB flash drive, etc. The memory 32 may be arranged inside the UAV body 20. The memory 32 can be configured to be detachable from the UAV body 20.

The UAV controller 30 controls the flight or photographing of the UAV 10 according to the program stored in the memory 32. The UAV controller 30 may include a central processing unit (CPU), a microprocessor such as a micro processing unit (MPU), or a microcontroller such as a microcontroller unit (MCU). The UAV controller 30 controls the flight and photographing of the UAV 10 according to the instructions received from the remote operation device 300 via the communication interface 34. The propeller 40 propels the UAV 10. The propeller 40 includes the plurality of rotors and a plurality of drive motors that rotate the plurality of rotors. The propeller 40 rotates the plurality of rotors through the plurality of drive motors according to the instruction from the UAV controller 30 to cause the UAV 10 to fly.

The GPS receiver 41 receives a plurality of signals indicating time transmitted from a plurality of GPS satellites. The GPS receiver 41 calculates the position (latitude and longitude) of the GPS receiver 41, i.e., the position (latitude and longitude) of the UAV 10, based on the received plurality of signals. The IMU 42 detects an attitude of the UAV 10. The IMU 42 detects accelerations in three directions of front/back, left/right, and up/down as well as angular velocities in three directions of the pitch axis, the roll axis, and the yaw axis, which are used as the attitude of the UAV 10. The magnetic compass 43 detects the direction of the head of the UAV 10. The barometric altimeter 44 detects a flight altitude of the UAV 10. The barometric altimeter 44 detects the air pressure around the UAV 10 and converts the detected air pressure into an altitude to detect the altitude. The temperature sensor 45 detects the temperature around the UAV 10. The humidity sensor 46 detects humidity around the UAV 10.

The photographing device 100 includes a photographing unit 102 and a lens unit 200. The lens unit 200 is an example of a lens device. The photographing unit 102 includes an image sensor 120, a photographing controller 110, and a memory 130. The image sensor 120 may include a charge-coupled device (CCD) or a complementary metal-oxide-semiconductor sensor (CMOS). The image sensor 120 captures an optical image formed by the plurality of lenses 210 and outputs the captured image data to the photographing controller 110. The photographing controller 110 may include a CPU, a microprocessor such as an MPU, or a microcontroller such as an MCU. The photographing controller 110 may control the photographing device 100 based on an operation instruction of the photographing device 100 from the UAV controller 30. The memory 130 may be a computer-readable storage medium and may include at least one flash memory such as SRAM, DRAM, EPROM, EEPROM, and/or USB flash drive. The memory 130 stores programs needed for the photographing controller 110 to control the image sensor 120, etc. The memory 130 may be arranged inside a case of the photographing device 100. The memory 130 may be configured to be detachable from the case of the photographing device 100.

The lens unit 200 includes a plurality of lenses 210, a plurality of lens driver 212, and a lens controller 220. The plurality of lenses 210 can include zoom lenses, focus adjustable lenses, and/or focusing lenses. At least some or all of the plurality of lenses 210 are configured to be able to move along the optical axis. The lens unit 200 may be an interchangeable lens configured to be detachable from the photographing unit 102. The lens driver 212 drives at least some or all of the plurality of lenses 210 to move along the optical axis via a mechanism component such as a cam ring. The lens driver 212 may include an actuator. The actuator may include a step motor. The lens controller 220 drives the lens driver 212 according to a lens control instruction from the photographing unit 102 to move one or more lenses 210 in the optical axis direction via the mechanism component. The lens control instruction can be, for example, a zoom control instruction or a focus control instruction.

The lens unit 200 also includes a memory 222, a position sensor 214, an aperture 234, an aperture driver 236, a filter 238, a filter driver 240, a shutter 230, and a shutter driver 232.

The lens controller 220 controls the lens driver 212 to move the lens 210 in the optical axis direction according to a lens operation instruction from the photographing unit 102. Some or all of the lens 210 can move along the optical axis. The lens controller 220 moves at least one of the lenses 210 along the optical axis to perform at least one of a zooming operation or a focusing operation. The position sensor 214 detects the position of the lens 210. The position sensor 214 can detect a current zoom position or focus position.

The lens driver 212 may include a vibration correction mechanism. The lens controller 220 may perform the vibration correction by moving the lens 210 in the optical axis direction or a direction perpendicular to the optical axis through the vibration correction mechanism. The lens driver 212 may perform the vibration correction by driving the vibration correction mechanism with the step motor. In some embodiments, the vibration correction mechanism may be driven by a step motor to move the image sensor 120 in the optical axis direction or in a direction perpendicular to the optical axis to perform vibration correction.

The aperture 234 adjusts the amount of light incident at the image sensor 120. The aperture 234 may include at least one blade component. The aperture driver 236 may include an actuator. The actuator may include a step motor. The aperture driver 236 can receive an instruction from the lens controller 220 to drive a step motor, adjust the overlapping degree of the plurality of blade components, to adjust the size of the aperture opening.

The filter 238 reduces the light amount of the light incident through the lens 210 or cuts the light at a specific wavelength. The filter 238 may include at least one of a neutral-density (ND) filter or an infrared cut filter. The filter driver 240 may include an actuator. The actuator may include a step motor. The filter driver 240 receives an instruction from the lens controller 220 to drive the step motor, so as to cause the filter 238 to move between a first position where the incident light passes through and a second position where the specific wavelength component of the input light is blocked or the input light is attenuated.

The shutter 230 may include at least one blade component. The shutter driver 232 may include an actuator. The actuator may include a step motor. The shutter driver 232 can receive an instruction from the lens controller 220 to drive the step motor, and adjust the overlapping speed of the plurality of blade components to switch the transmission or blocking of light at a desired speed.

The photographing device 100 is an example of a device with a step motor. The lens 210, shutter 230, aperture 234, filter 238, and vibration correction mechanism are examples of optical components driven by step motors.

The memory 222 stores control values of the plurality of lenses 210 driven by the lens driver 212. The memory 222 may include at least one flash memory such as SRAM, DRAM, EPROM, EEPROM, and/or USB flash drive.

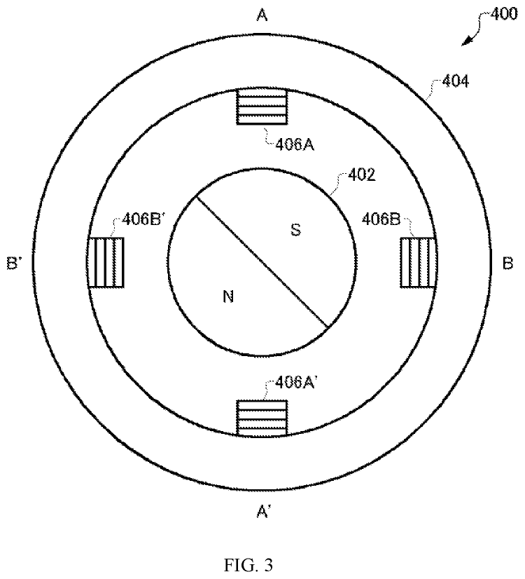

FIG. 3 is a diagram for describing the step motor. The step motor includes a rotor 402 and a stator 404. The stator 404 includes an A-phase coil 406A, a B-phase coil 406B, an A′-phase coil 406A′, and a B′-phase coil 406B′ (each may be generally referred to as a coil 406). The step motor drives with a plurality of control modes. The plurality of control modes may include a first control mode and a second control mode. In the second control mode, (1) a number of steps is smaller than that in the first control mode, and (2) a force to keep the rotor 402 at a first position is smaller than that of the first control mode or the power consumption is less than the power consumption of the first control mode. Step motors may drive, for example, in a micro-step mode, a one-phase excitation mode, a two-phase excitation mode, or a one-two-phase excitation mode (sometimes each of the one-phase excitation mode, the two-phase excitation mode, and the one-two-phase excitation mode is also referred to as a phase excitation mode). The rotor 402 is rotated by applying a predetermined voltage to each of the plurality of coils 406 according to the control mode.

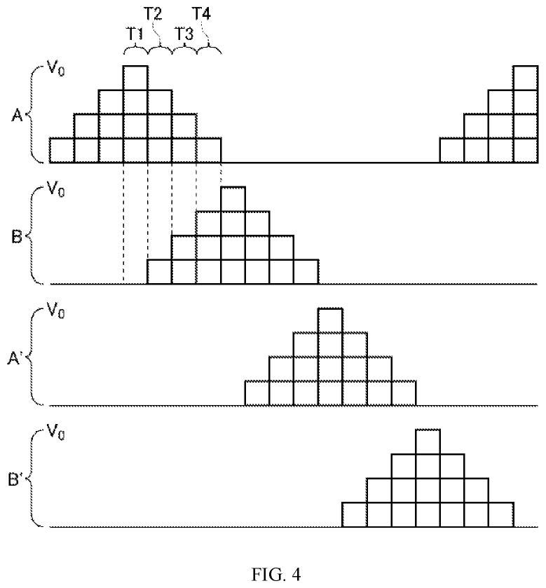

FIG. 4 shows example voltage pattern applied to the coils 406 of various phases in the micro-step mode. In the micro-step mode, in each step, a voltage is applied to the coil 406 of one phase or each of the coils 406 of two phases. For example, in period T1, a voltage of Vo is applied to the A-phase coil 406A. In period T2, a voltage of ¾ Vo is applied to the A-phase coil 406A, and a voltage of ¼ Vo is applied to the B-phase coil 406B. In period T3, a voltage of ½ Vo is applied to the A-phase coil 406A, and a voltage of ½ Vo is applied to the B-phase coil 406B. In period T4, a voltage of ¼ Vo is applied to the A-phase coil 406A, and a voltage of ¾ Vo is applied to the B-phase coil 406B.

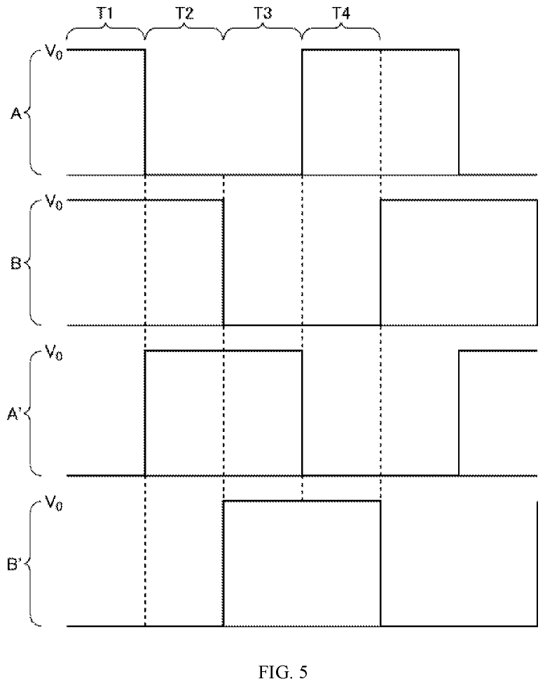

FIG. 5 shows example voltage pattern applied to the coils 406 of various phases in the two-phase excitation mode. In the two-phase excitation mode, in each step, a voltage is applied to the coils 406 of two phases. For example, in period T1, a voltage of Vo is applied to the A-phase coil 406A, and a voltage of Vo is applied to the B-phase coil 406B. In period T2, a voltage of Vo is applied to the B-phase coil 406B, and a voltage of Vo is applied to the A′-phase coil 406A′. In period T3, a voltage of Vo is applied to the A′-phase coil 406A′, and a voltage of Vo is applied to the B′-phase coil 406B′. In period T4, a voltage of Vo is applied to the B′-phase coil 406B′, and a voltage of Vo is applied to the A-phase coil 406A.

The micro-step mode is an example of the first drive mode. A phase excitation mode is an example of the second drive mode. For a step motor driven in a micro-step mode, voltages of more than eight voltage patterns can be applied. For a step motor driven in a phase excitation mode, voltages of eight or less than eight voltage patterns can be applied. For example, for a step motor driven in the one-phase excitation mode or the two-phase excitation mode, voltages of four voltage patterns can be applied, while for a step motor driven in the one-two-phase excitation mode, voltages of eight voltage patterns can be applied.

In the one-phase excitation mode or the two-phase excitation mode, the holding force of the coils 406 for the rotor 402 is substantially unchanged in various steps. In the one-two-phase excitation mode, when a voltage is applied to the coil 406 of one phase, the holding force of the coils 406 for the rotor 402 is essentially the same as the holding force in the one-phase excitation mode. When voltages are applied to the coils 406 of two phases, the holding force of the coils 406 for the rotor 402 is essentially the same as the holding force in the two-phase excitation mode.

In the micro-step mode, the voltages applied to the coils 406 may change in various steps. Therefore, the holding force of the coils 406 for the rotor 402 may change in various steps. Moreover, in the micro-step mode, the holding force to at least keep the rotor 402 at the first position is smaller than the holding force in the one-phase excitation mode, the two-phase excitation mode, or the one-two-phase excitation mode or the power consumption is smaller than the power consumption of any phase excitation mode.

As described above, when the step motor operates in the micro-step mode, the rotor 402 is sometimes held at a stop position where the holding force is smaller than the holding force of the step motor is operated in a phase excitation mode. When the photographing device 100 with the step motor is carried by the UAV 10 and the UAV 10 is in flight, the holding force to keep the rotor 402 may be reduced due to a vibration during the flight of the UAV 10. In this case, the rotor 402 may not be stopped at a desired stop position, and therefore, optical components such as the lens 210 driven by the step motor may be displaced from the desired position.

In some embodiments, in the micro-step mode, the step motor generates heat more easily compared to in the phase excitation mode. Therefore, when the surrounding temperature is high, the phase excitation mode is sometimes preferred to the micro-step mode.

In some embodiments, when the UAV 10 is moving or the UAV 10 is vibrating, for example, even if a step motor is operated in a micro-step mode to drive the optical components such as a focusing lens, effects such as improving the image quality of the image captured by the photographing device 100 sometimes may not be obtained. As described above, the power consumption in the micro-step mode is more than the power consumption in the phase excitation mode. Therefore, in this case, power is wasted. Therefore, when the step motor can keep the rotor 402 at a desired stop position, the step motor is sometimes chosen not to work in the micro-step mode, but to work in the phase excitation mode.

As described above, the appropriate drive mode of the step motor at the photographing device 100 carried by the UAV 10 sometimes may be different according to the flight status of the UAV 10 or the environment where the UAV 10 is located.

Therefore, in some embodiments, the photographing device 100 switches the drive modes of the step motor according to the flight status of the UAV 10 or the environment of the UAV 10. Therefore, the step motor can be controlled more appropriately according to the movement status of the UAV 10 or the environment where the UAV 10 is located.

As shown in FIG. 2, the lens controller 220 includes an acquisition unit 224 and a drive controller 226. The acquisition unit 224 acquires at least one of the movement information related to the movement status of the photographing device 100 or the environment information related to the environment where the photographing device 100 is located. The acquisition unit 224 may acquire information related to at least one of an acceleration of the photographing device 100 or a speed of the photographing device 100 as the movement information. The acquisition unit 224 may acquire information related to at least one of an acceleration of the UAV 10 or a speed of the UAV 10 as the movement information. The acquisition unit 224 can acquire the information indicating the acceleration of the UAV 10 from the inertial measurement device 42 through the UAV controller 30 and the photographing controller 110 as the movement information. The acquisition unit 224 can acquire the information indicating the speed of the UAV 10 from the GPS receiver 41 through the UAV controller 30 and the photographing controller 110 as the movement information.

The acquisition unit 224 may acquire information related to at least one of the altitude of the photographing device 100, the temperature around the photographing device 100, or the humidity around the photographing device 100 as the environment information. The acquisition unit 224 can acquire information related to at least one of the altitude of the UAV 10, the temperature around the UAV 10, or the humidity around the UAV 10 as the environment information. The acquisition unit 224 can acquire the altitude of the UAV 10 from the barometric altimeter 44 through the UAV controller 30 and the photographing controller 110 as the environment information. The acquisition unit 224 can acquire information indicating the temperature around the UAV 10 from the temperature sensor 45 through the UAV controller 30 and the photographing controller 110 as the environment information. The acquisition unit 224 can acquire information indicating the humidity around the UAV 10 from the humidity sensor 46 through the UAV controller 30 and the photographing controller 110 as the environment information.

The drive controller 226 controls the step motor by switching among the plurality of control modes according to at least one of the movement information or the environment information. The drive controller 226 is an example of a controller. When the acceleration of the photographing device 100 is smaller than a predetermined acceleration, or the speed of the photographing device 100 is slower than a predetermined speed, the drive controller 226 may control the step motor in the micro-step mode. When the acceleration of the photographing device 100 is greater than the predetermined acceleration, or the speed of the photographing device 100 is faster than the predetermined speed, the drive controller 226 may control the step motor in the one-phase excitation mode, the two-phase excitation mode, or the one-two-phase excitation mode. When the acceleration of the UAV 10 is smaller than the predetermined acceleration, or the speed of the UAV 10 is slower than the predetermined speed, the drive controller 226 may control the step motor in the micro-step mode. When the acceleration of the UAV 10 is greater than a predetermined acceleration, or the speed of the UAV 10 is faster than a predetermined speed, the drive controller 226 may control the step motor in one-phase excitation mode, two-phase excitation mode, or one-two-phase excitation mode. When the UAV 10 is in a hovering status, the drive controller 226 may control the step motor in a micro-step mode. The drive controller 226 can determine whether the UAV 10 is in a hovering status according to the acceleration of the UAV 10, the speed of the UAV 10, the altitude of the UAV 10, etc.

When the altitude of the photographing device 100 is higher than a predetermined altitude, the temperature around the photographing device 100 is lower than a predetermined temperature, or the humidity around the photographing device 100 is lower than a predetermined humidity, the drive controller 226 may control the step motor in the micro-step mode. When the temperature around the photographing device 100 is higher than the predetermined temperature, or the humidity around the photographing device 100 is higher than the predetermined humidity, the drive controller 226 may control the step motor in the one-phase excitation mode, the two-phase excitation mode, or the one-two-phase excitation mode. When the altitude of the UAV 10 is higher than the predetermined altitude, the temperature around the UAV 10 is lower than the predetermined temperature, or the humidity around the UAV 10 is lower than the predetermined humidity, the drive controller 226 may control the step motor in the micro-step mode. When the temperature around the UAV 10 is higher than the predetermined temperature, or the humidity around the UAV 10 is higher than the predetermined humidity, the drive controller 226 may control the step motor in the one-phase excitation mode, the two-phase excitation mode, or the one-two-phase excitation mode.

The acquisition unit 224 may also acquire setting information related to the photographing setting content of the photographing device 100. As the setting content of the photographing device 100, the acquisition unit 224 may acquire the setting information such as the zoom position of the photographing device 100, the F value of the photographing device 100, the photographing direction of the photographing device 100 with respect to the UAV 10, and the photographing mode (sport mode, landscape mode, etc.) of the photographing device 100, etc.

The drive controller 226 may control the step motor by switching the plurality of control modes according to the setting information. When a photographing condition based on at least one of the movement information, the environment information, or the setting information satisfies a predetermined photographing condition, and a drive condition of the step motor based on at least one of the movement information or the environment information satisfies a predetermined drive condition, the drive controller 226 may control the step motor in the micro-step mode. On the other hand, when the photographing condition does not satisfy the predetermined photographing condition, the drive controller 226 may control the step motor in the one-phase excitation mode, the two-phase excitation mode, or the one-two-phase excitation mode no matter whether the drive condition satisfies the predetermined drive condition.

In a scenario that the photographing device 100 is photographing when the angle formed by the moving direction of the UAV 10 and the photographing direction of the photographing device 100 is within a predetermined angle range, or the speed of the UAV 10 is slower than the predetermined speed V1, the drive controller 226 can determine that the photographing condition satisfies a predetermined condition. When the moving direction of the photographing device 100 is the same as the photographing direction of the photographing device 100, the drive controller 226 may determine that the photographing condition satisfies a predetermined condition. The predetermined photographing condition may be a condition that is satisfied when the photographing device 100 can capture an image with the desired image quality by controlling the step motor in the micro-step mode to drive optical components such as a focusing lens, an aperture, etc. The predetermined photographing condition may be a condition that is satisfied when the blur amount is smaller than a predetermined threshold by controlling the step motor in the micro-phase mode to drive the optical components such as the focusing lens, the aperture, etc.

When the acceleration of the UAV 10 is smaller than the predetermined acceleration, the speed of the UAV 10 is slower than the predetermined speed V2 (>V1), the temperature around the UAV 10 is lower than the predetermined temperature, or the humidity around the UAV 10 is lower than the predetermined humidity, the drive controller 226 may determine that the drive conditions of the step motor meet the predetermined drive conditions.

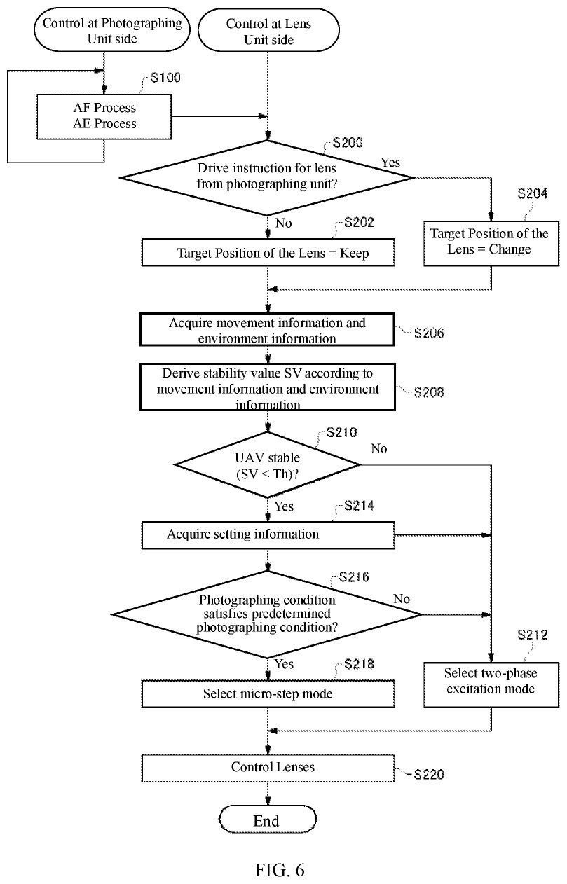

FIG. 6 is a flowchart showing an example of a method for driving the lens 210. For the control at the photographing unit 102 side, the photographing controller 110 performs an automatic focus process or an automatic exposure process (S100). On the other hand, for the control at the lens unit 200 side, the lens controller 220 determines whether there is a drive instruction for the lens 210 from the photographing unit 102 (S200). If there is no new drive instruction for the lens 210, the lens controller 220 determines to maintain the target position of the lens 210 to be the current position (S202). On the other hand, if there is a new drive instruction for the lens 210, the lens controller 220 determines to change the target position of the lens 210 according to the drive instruction (S204).

The acquisition unit 224 acquires the movement information and the environment information through the UAV controller 30 and the photographing unit 102 (S206). The drive controller 226 derives a stability value SV according to the movement information and the environment information (S208).

For example, the stability value SV can be derived according to the following formula.

Stability value SV=acceleration×K1+altitude×K2+GPS change×K3+temperature×K4+humidity×K5

where, K1, K2, K3, K4, and K5 are weights. The larger the SV is, the more unstable the UAV 10 is. The weights can be set in advance. The weights can be set by the user according to the photographing environment.

After the stability value SV is derived, the drive controller 226 determines whether the UAV 10 is stable according to the stability value SV (S210). The drive controller 226 can determine whether the UAV 10 is stable based on whether the stability value SV is smaller than a threshold Th. If the stability value SV is greater than the threshold Th, the drive controller 226 determines that the UAV 10 is unstable and selects the two-phase excitation mode as the drive mode of the step motor of the lens 210 (S212). In some embodiments, the drive controller 226 may select the one-phase excitation mode or the one-two-phase excitation mode.

If the stability value SV is less than the threshold Th, the acquisition unit 224 also acquires the setting information of the photographing device 100 through the photographing controller 110 (S214). The drive controller 226 determines the photographing conditions of the photographing device 100 based on the movement information, the environment information, and the setting information. The drive controller 226 can determine, for example, whether an angle formed by the moving direction of the UAV 10 and the photographing direction of the photographing device 100 is within the predetermined angle range. The drive controller 226 can determine whether the photographing device 100 performs photographing when the speed of the UAV 10 is slower than a predetermined speed V1.

When the determined photographing conditions do not satisfy the predetermined photographing conditions, to suppress the power consumption of the step motor of the lens 210, the drive controller 226 selects the two-phase excitation mode as the drive mode of the step motor of the lens 210 (S212). In some embodiments, the drive controller 226 may select the one-phase excitation mode or the one-two-phase excitation mode.

In some embodiments, when the determined photographing conditions satisfy the predetermined photographing conditions, the drive controller 226 selects the micro-step mode as the drive mode of the step motor of the lens 210 (S218).

The drive controller 226 controls the lens 210 by driving the step motor according to the selected drive mode (S220).

Consistent with embodiments of the disclosure, the photographing device 100 switches the drive modes for the step motor according to the flight status of the UAV 10 or the environment of the UAV 10. For example, when the flight of the UAV 10 is unstable, the step motor for the optical components can be driven using a phase excitation mode that can further maintain the rotor 402. Accordingly, when the flight of the UAV 10 is unstable, it is possible to suppress the situation where the rotor 402 cannot be stopped at a desired stop position or the optical components displaced from the desired positions. In some embodiments, if the photographing device 100 still cannot capture an image with the desired image quality even when the step motor is driven in the micro-step mode, the step motor can still be driven in a phase excitation mode, so as to prevent power consumption from being meaninglessly wasted.

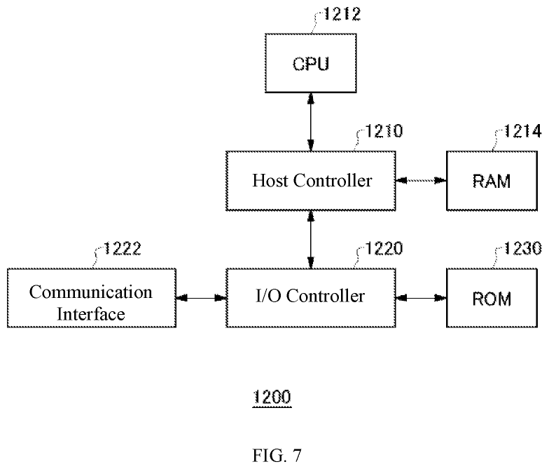

FIG. 7 shows an example of a computer 1200 that can fully or partially implement one or more of the plurality of methods of the present disclosure. The program installed on the computer 1200 enables the computer 1200 to function as an operation associated with a device according to an embodiment of the present disclosure or one or more “units” of the device. In some embodiments, the program enables the computer 1200 to execute the operation or to be the one or more “units.” This program enables the computer 1200 to execute a process or a stage of the process according to an embodiment of the present disclosure. The program may be executed by a CPU 1212 to enable the computer 1200 to execute specified operations associated with some or all of the blocks in the flowcharts or block diagrams described in the specification.

As shown in FIG. 7, the computer 1200 includes the CPU 1212 and a RAM 1214, which are connected to each other through a host controller 1210. The computer 1200 also includes a communication interface 1222, and an I/O unit. The communication interface 1222 and the I/O unit are connected to the host controller 1210 through an I/O controller 1220. The computer 1200 also includes a ROM 1230. The CPU 1212 operates according to programs stored in the ROM 1230 or the RAM 1214 to control each unit.

The communication interface 1222 communicates with other electronic devices through a network. The hard drive can store programs and data used by the CPU 1212 of the computer 1200. The ROM 1230 stores a boot program, etc., executed by the computer 1200 during operation, and/or a program that depends on the hardware of the computer 1200. The program is provided through a computer-readable storage medium such as a CR-ROM, a USB flash drive, or an IC card, or a network. The program is installed in a computer-readable recording medium such as the RAM 1214 or the ROM 1230 and is executed by the CPU 1212. The information processing described in the program is read by the computer 1200 and causes the cooperation between the program and the above-mentioned various types of the hardware resources. The device or method can be implemented by or in the computer 1200 to realize the operation or processing the information.

For example, when the computer 1200 communicates with an external device, the CPU 1212 may execute a communication program uploaded in the RAM 1214 and instruct the communication interface 1222 to perform communication processing based on the processing described in the communication program. The communication interface 1222 is controlled by the CPU 1212 to read the transmission data stored in a transmission buffer provided by a storage medium such as the RAM 1214 or the USB flash drive, and send the read transmission data to the network, or writes the received data from the network to a receive buffer, etc., provided by the storage medium.

In some embodiments, the CPU 1212 can enable the RAM 1214 to read all or needed portions of a file or database stored in an external storage medium such as a USB flash drive, and perform various types of processing on the data of the RAM 1214. The CPU 1212 can write the processed data back to the external storage medium.

Various types of information such as various types of programs, data, tables, or databases may be stored in the storage medium and subjected to the information processing. For the data read from the RAM 1214, the CPU 1212 can perform various types of processing, including the various operations, the information processing, conditional judgment, conditional transfer, unconditional transfer, information retrieval/replacement, etc., specified by an instruction sequence of the program, and write results back to the RAM 1214. In some embodiments, the CPU 1212 can retrieve the information in files, databases, etc. in the storage medium. For example, when a plurality of entries of an attribute value of a first attribute respectively associated with an attribute value of a second attribute are stored in the storage medium, the CPU 1212 may retrieve the entry matching the attribute value of the first attribute from the plurality of entries and read the attribute value of the second attribute stored in the entry to obtain the attribute of the second attribute associated with the first attribute that satisfies the predetermined condition.

The programs or software described above may be stored on the computer 1200 or a computer-readable storage medium near the computer 1200. In some embodiments, the storage medium such as a hard drive or a RAM provided in a server system connected to a special purpose communication network or the Internet can be configured as a computer-readable storage medium, so that the program can be provided to the computer 1200 through the network.

In the claims, the specification, and the drawings, the execution order of the various processes such as the operation, the sequence, steps, stages, etc., in the devices, systems, programs, or methods can be implemented with any sequence, unless specifically stated “before . . . ,” “in advance,” etc., and as long as the output of the previous process is not used in a subsequent process. Regarding the operation flow in the claims, the description, and the drawings, “first,” “next,” etc., have been used in description for convenience, but the implementation in the order is not necessary.

What is claimed is:

1. A control apparatus comprising:
a processor; and
a memory storing a program that, when executed by the processor, causes the processor to:
acquire at least one of movement information related to a movement status of a device having a step motor or environment information related to an environment where the device is located; and
select one of a plurality of control modes to control the step motor according to the at least one of the movement information or the environment information;
wherein:
the plurality of control modes include a first control mode and a second control mode;
a number of steps of the second control mode is less than a number of steps of the first control mode; and
a force to keep a rotor of the step motor at a position in the second control mode is smaller than a force to keep the rotor at the position in the first control mode, or a power consumption of the second control mode is less than a power consumption of the first control mode.

2. The control apparatus of claim 1, wherein:
the movement information includes information related to at least one of an acceleration of the device or a speed of the device; and
the program further causes the processor to control the step motor with the first control mode in response to the acceleration of the device being smaller than a predetermined acceleration or the speed of the device being slower than a predetermined speed.

3. The control apparatus of claim 2, wherein the program further causes the processor to control the step motor with the second control mode in response to the acceleration of the device being greater than the predetermined acceleration or the speed of the device being faster than the predetermined speed.

4. The control apparatus of claim 1, wherein:
the environment information includes information related to at least one of an altitude of the device, a temperature around the device, or a humidity around the device; and
the program further causes the processor to control the step motor with the first control mode in response to the altitude of the device being higher than a predetermined altitude, the temperature around the device being lower than a predetermined temperature, or the humidity around the device being lower than a predetermined humidity.

5. The control apparatus of claim 4, wherein the program further causes the processor to control the step motor with the second control mode in response to the temperature around the device being higher than the predetermined temperature or the humidity around the device being higher than the predetermined humidity.

6. The control apparatus of claim 1, wherein:
the device is carried by a mobile body;
the movement information includes information related to at least one of an acceleration of the mobile body or a speed of the mobile body; and
the program further causes the processor to control the step motor with the first control mode in response to the acceleration of the mobile body being smaller than a predetermined acceleration or the speed of the mobile body being slower than a predetermined speed.

7. The control apparatus of claim 6, wherein the program further causes the processor to control the step motor with the second control mode in response to the acceleration of the mobile body being greater than the predetermined acceleration or the speed of the mobile body being faster than the predetermined speed.

8. The control apparatus of claim 1, wherein:
the device is carried by an unmanned aerial vehicle (UAV); and
the program further causes the processor to control the step motor with the first control mode in response to the UAV being in hovering status.

9. The control apparatus of claim 1, wherein:
the device is a photographing device; and
the program further causes the processor to control the step motor to:
acquire setting information related to photographing setting contents of the photographing device; and
select one of the plurality of control modes according to the setting information.

10. The control apparatus of claim 9, wherein the photographing device further includes an optical component driven by the step motor.

11. The control apparatus of claim 10, wherein the optical component includes at least one of a focusing lens, a zoom lens, an aperture, a shutter, a filter, or a vibration correction mechanism.

12. The control apparatus of claim 9, wherein:
the device is carried by a mobile body;
the movement information includes information related to at least one of an acceleration of the mobile body or a speed of the mobile body, and the environment information includes information related to at least one of an altitude of the mobile body, a temperature around the mobile body, or a humidity around the mobile body; and
the program further causes the processor to:
control the step motor with the first control mode in response to:
a photographing condition based on the at least one of the movement information, the environment information, or the setting information satisfying a predetermined photographing condition, and
a drive condition of the step motor based on the at least one of the movement information or the environment information satisfying a predetermined drive condition; and control the step motor with the second control mode in response to the photographing condition not satisfying the predetermined photographing condition.

13. The control apparatus of claim 12, wherein the program further causes the processor to:
determine that the photographing condition satisfies the predetermined photographing condition in response to:
an angle between a moving direction of the mobile body and a photographing direction of the photographing device being within a predetermined angle range, or
the photographing device performing photographing while the speed of the mobile body being slower than a first speed; and
determining that the drive condition satisfies the predetermined drive condition in response to:
the acceleration of the mobile body being smaller than a predetermined acceleration,
the speed of the mobile body being slower than a second speed faster than the first speed,
the temperature around the mobile body being lower than a predetermined temperature, or
the humidity around the mobile body being lower than a predetermined humidity.

14. The control apparatus of claim 1, wherein:
the number of steps of the first control mode is greater than eight; and
the number of steps of the second control mode is smaller than eight.

15. The control apparatus of claim 1, wherein:
the first control mode is a micro-step mode; and
the second control mode is a one-phase excitation mode, a two-phase excitation mode, or a one-two-phase excitation mode.

16. A photographing device comprising:
the controller of claim 1;
the step motor; and
an optical component configured to be driven by the step motor.

17. A mobile body comprising the photographing device of claim 16.

18. The mobile body of claim 17, further comprising:
a support mechanism configured to rotatably support the photographing device.

19. A control method comprising:
acquiring at least one of movement information related to a movement status of a device having a step motor or environment information related to an environment where the device is located; and
selecting one of a plurality of control modes to control the step motor according to the at least one of the movement information or the environment information;
wherein:
the plurality of control modes include a first control mode and a second control mode;
a number of steps of the second control mode is less than a number of steps of the first control mode; and
a force to keep a rotor of the step motor at a position in the second control mode is smaller than a force to keep the rotor at the position in the first control mode, or a power consumption of the second control mode is less than a power consumption of the first control mode.

20. The control method of claim 19, further comprising:
controlling the step motor with the first control mode in response to an acceleration of the device being smaller than a predetermined acceleration or a speed of the device being slower than a predetermined speed, wherein the movement information includes information related to at least one of the acceleration of the device or the speed of the device.
